(19) United States
(12) Patent Application Publication
(10) Pub. No.: US 2024/0414636 A1
(43) Pub. Date: Dec. 12, 2024

(54) USER EQUIPMENT AND METHOD TO FORBID PLMN OR SNPN AND HANDLE EMERGENCY CALL DUE TO DEREGISTRATION

(71) Applicant: MediaTek Singapore Pte. Ltd., Singapore (SG)

(72) Inventors: Puneet Puneet, Bengaluru (IN); Yuan-Chieh LIN, Hsinchu City (TW)

(21) Appl. No.: 18/674,992

(22) Filed: May 27, 2024

(30) Foreign Application Priority Data
Jun. 9, 2023 (IN) 202321039553
Jun. 9, 2023 (IN) 202321039554
Jun. 9, 2023 (IN) 202321039555

(51) Int. Cl. H04W 48/16; H04W 60/06; H04W 84/04

(52) U.S. Cl. CPC H04W 48/16; H04W 60/06; H04W 84/04

(57) ABSTRACT

A user equipment and a method to forbid PLMN or SNPN and handle emergency call due to deregistration are provided. The method includes: monitoring an operation of the UE; and controlling the UE to start a timer for enabling a network access mode capability for the 3GPP access when the UE disables the network access mode capability for 3GPP access due to a network initiated procedure. The UE memorizes an identity of PLMNs or SNPNs where the network access mode capability for the 3GPP access was disabled.

This application claims the benefit of India Provisional application Ser. No. 202321039553, filed Jun. 9, 2023, India Provisional application Ser. No. 202321039554, filed Jun. 9, 2023, and India Provisional application Ser. No. 202321039555, filed Jun. 9, 2023, the disclosure of which is incorporated by reference herein in its entirety.

### TECHNICAL FIELD

The disclosure relates in general to a user equipment and a method thereof, and more particularly to a user equipment and a method to forbid PLMN or SNPN and handle emergency call due to deregistration.

### BACKGROUND

In the wireless communication technology, SNPN stands for Standalone Non-Public network. The network initiates the de-registration procedure by sending de-registration request with 5GMM/EMM cause value.

DEREGISTRATION REQUEST, other 5GMM cause values than those treated in subclause 5.5.2.3.2, cases of 5GMM cause value #11, #15, #22, #72, #74, #75, #76, #77, #78, #79 and #93 that are considered as abnormal cases according to TS 24.501 subclause 5.5.2.3.2 or no 5GMM cause IE is included, and the De-registration type IE indicates “re-registration not required”, then enter the state PLMN-SEARCH to perform PLMN selection procedure.

Further, the UE could establish an emergency PDU session to process emergency call.

In abnormal case of network-initiated deregistration procedure, the UE starts T3502 (Similarly T3402) timer and enter the state 5GMM-DEREGISTERED. PLMN-SEARCH (similarly EMM-DEREGISTERED. PLMN-SEARCH).

If UE change the state to PLMN-SEARCH state, then the UE can camp on same PLMN (or SNPN) or a different PLMN (or SNPN), then the T3502 timer will be stopped upon PLMN (or SNPN) changes.

If network-initiated deregistration procedure is failed due to abnormal cases on different PLMN (on SNPN), then the UE will change the state to PLMN-SEARCH, then the UE can camp on same PLMN (or SNPN) where T3502 timer is running or different PLMN (or SNPN) and the UE's initial registration procedure can be rejected on a PLMN (or SNPN) where T3502 timer was started or running, but T3502 timer is stopped due to PLMN (or SNPN) change or the UE can stuck in deadlock loop. Currently, there is no method to avoid initial registration reject or break deadlock or loop.

For example, there are 2 PLMNs (PLMNA, PLMN B) are available:
1. The UE is registered on PLMN A and network has triggered network-initiated registration procedure is failed due to abnormal cases. A first T3502 timer will be stopped upon PLMN change if running. The UE will start a second T3502 timer and perform PLMN selection procedure.
2. The UE finds PLMN B and registered on PLMN B. The second T3502 timer will be stopped upon PLMN change if running. The network has triggered network-initiated registration procedure and it is failed due to abnormal cases on PLMNB. The UE will start a third T3502 timer and perform PLMN selection procedure.
3. The step 1 and step 2 are repeated in loop and the UE will stuck in loop of registration and overload the signaling in network since network is still congested.

Moreover, in abnormal case of the network-initiated de-registration procedure, UE starts T3502 (Similarly T3402) timer and disable the N1 mode capability for selection PLMN or SNPN in both 3GPP and non-3GPP (similarly S1 mode capability).

Currently, the UE behavior is not defined when there is request from upper layer to establish an emergency PDU session or to trigger an emergency registration in a PLMN or SNPN when N1 mode (S1 mode) capability for that PLMN or SNPN was disabled in both 3GPP and/or non-3GPP due to network-initiated de-registration procedure (detach procedure).

### SUMMARY

The disclosure is directed to a user equipment and a method to forbid PLMN or SNPN due to network initiated de-registration procedure in mobile communication or to handle emergency call in deregistered state in mobile communication.

According to one embodiment, a method for operating a user equipment (UE) is provided. The method includes: monitoring an operation of the UE; and controlling the UE to start a timer for enabling a network access mode capability for the 3GPP access when the UE disables the network access mode capability for 3GPP access due to a network initiated procedure. The UE memorizes an identity of PLMNs or SNPNs where the network access mode capability for the 3GPP access was disabled.

According to another embodiment, a method for operating a user equipment (UE) is provided. The method includes: monitoring an operation of the UE; and controlling the UE to enable a network access mode capability for that SNPN memorized by the UE, if the UE attempts to establish an emergency PDU session in a SNPN where the network access mode capability was disabled due to a registration attempt counter of the UE have reached a maximum value.

According to an alternative embodiment, a user equipment (UE). The UE includes a transceiver and a processor. The transceiver is configured to wirelessly communicate with a network. The processor is coupled to the transceiver and configured to perform operations comprising: monitoring an operation of the UE; and controlling the UE to start a timer for enabling a network access mode capability for the 3GPP access when the UE disables the network access mode capability for 3GPP access due to a network initiated procedure. The UE memorizes an identity of PLMNs or SNPNs where the network access mode capability for the 3GPP access was disabled.

### BRIEF DESCRIPTION OF THE DRAWINGS

FIG. 1 shows a schematic diagram of a mobile communication system according to an embodiment of the present disclosure.

FIG. 2 shows a flowchart of a method to forbid PLMN or SNPN due to network initiated procedure (network initiated deregistration procedure or network initiated detach procedure) in mobile communication according to one embodiment of the present disclosure.

FIG. 3 shows a flowchart of a method to handle emergency call in deregistered state in mobile communication according to one embodiment of the present disclosure.

FIG. 4 illustrates the user equipment (UE) in accordance with an implementation of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

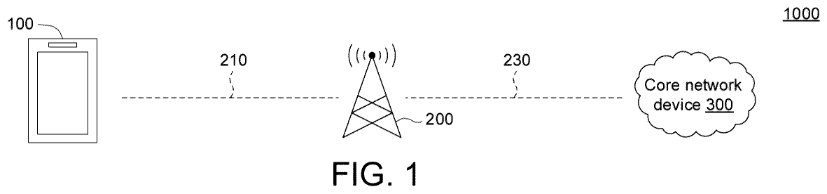

Please refer to FIG. 1, which shows a schematic diagram of a mobile communication system 1000 according to an embodiment of the present disclosure. The mobile communication system 1000 may be a long term evolution (Long Term Evolution, LTE) system, a fifth-generation mobile communication technology 5G new radio (new radio, NR) system, a machine to machine (Machine To Machine, M2M) system, or a future evolved sixth-generation communication system. The mobile communication system 1000 includes a user equipment (UE) 100, a base station 200 and a core network device 300. The base station 200 and the core network device 300 may be collectively referred to as a network device.

The base station 200 may be configured to perform mutual conversion between a received radio frame and an IP packet, and may further coordinate attribute management on an air interface. For example, the base station 200 may be an evolved NodeB (evolved NodeB, eNB) in LTE, or a base station that has a centralized distributed architecture and that is used in a 5G system. The base station 200 may also be an access point (Access Point, AP), a transmission node (Trans Point, TRP), a central unit (Central Unit, CU), or another network entity, and may include some or all of functions of the foregoing network entities. In addition, the base station 200 further includes a relay station. The relay station is a transmission station that receives data and/or other information from an upstream station and sends data and/or other information to a downstream station. The relay station may also be a terminal that provides relay transmission for another terminal. The relay station may also be referred to as a repeater.

The mobile communication system 1000 may be a heterogeneous system including different types of base stations (for example, a macro base station, a picocell base station, a femto base station, and a repeater). These different types of base stations may have different transmit power levels, different coverage areas, and different interference impact. For example, the macro base station may have a high transmit power level (for example, 20 watts), and the picocell station, the femto base station, and the repeater may have a low transmit power level (for example, 1 watt).

The base station 200 and the user equipment 100 establish a radio connection through a radio air interface. The radio air interface may be a radio air interface based on an LTE standard, or the radio air interface is a radio air interface based on a 5G standard. For example, the radio air interface is NR, or the radio air interface may be a radio air interface based on a 5G-based technology standard of a more next-generation mobile communication network.

The user equipment 100 may be a device that provides voice and/or data communication for a user. The user equipment 100 may communicate with one or more core network devices 300 through a radio access network (Radio Access Network, RAN) provided by the base station 200. The user equipment 100 may be a mobile terminal, for example, a mobile phone or a computer that has a mobile terminal, for example, a portable, pocket-sized, handheld, computer built-in, or vehicle-mounted mobile apparatus.

Specifically, the base station 200 may be configured to communicate with the user equipment 100 through a wireless interface 210 under control of a network device controller (not shown in the FIG. 1). In some embodiments, the network device controller may be a part of the core network device 300, or may be integrated into the base station 200. The base station 200 may transmit information or user data to the core network device 300 through an interface 230 (for example, an S1 interface). The base station 200 and the core network device 300 may also communicate with each other through an interface (for example, an X2 interface, which is not shown in the FIG. 1).

In abnormal case of network-initiated deregistration procedure, the UE 100 starts T3502 (Similarly T3402) timer and enter the state 5GMM-DEREGISTERED. PLMN-SEARCH (similarly EMM-DEREGISTERED. PLMN-SEARCH). Currently, there is no method to avoid initial registration reject or break deadlock or loop. To solve this problem, a method to forbid PLMN or SNPN due to network initiated procedure (network initiated deregistration procedure or network initiated detach procedure) in mobile communication is provided.

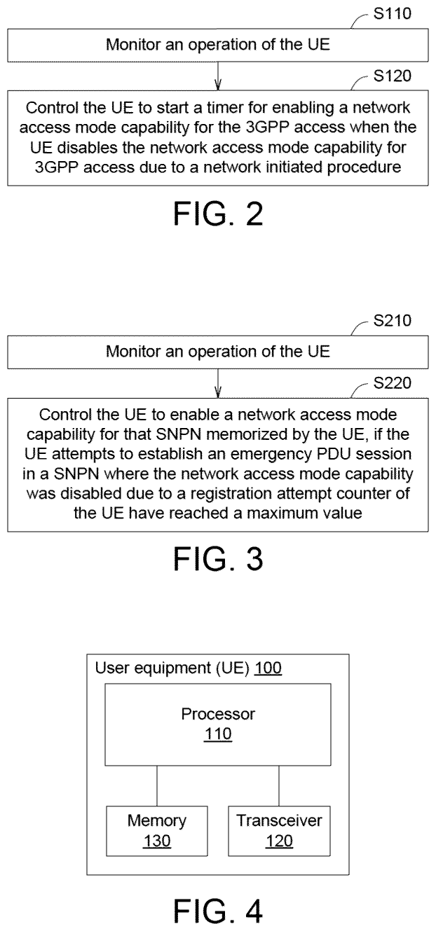

Please refer to FIG. 2, which shows a flowchart of a method to forbid PLMN or SNPN due to network initiated procedure (network initiated deregistration procedure or network initiated detach procedure) in mobile communication according to one embodiment of the present disclosure. The method includes steps S110 to S120. In the step S110, an operation of the UE 100 is monitored.

Next, in the step S120, the UE 100 is controlled to start a timer for enabling a network access mode capability for the 3GPP access when the UE 100 disables the network access mode capability for 3GPP access due to a network initiated procedure (a network initiated deregistration procedure or a network initiated detach procedure). In particular, the UE 100 memorizes an identity of PLMNs or SNPNs where the network access mode capability for the 3GPP access was disabled.

The UE behavior in Disabling and re-enabling of UE's network access mode capability for 3GPP access is defined as follows. The network access mode capability could be a N1 mode capability or an EUTRA mode capability. The network initiated procedure could be the network initiated deregistration procedure or the network initiated detach procedure.

As an implementation option, the UE 100 may start a timer for enabling the network access mode capability (the N1 mode capability or the EUTRA mode capability) for 3GPP access when the UE 100 disables the network access mode capability for 3GPP access. The UE 100 should memorize the identity of the PLMNs or SNPNs where the network access mode capability for 3GPP access was disabled. On expiry of this timer:
if the UE 100 is in the lu mode or the A/Gb mode and is in idle mode as specified in 3GPP TS 24.008, the UE 100 should enable the network access mode capability for 3GPP access;
if the UE 100 is in the lu mode and a PS signalling connection exists, but no RR connection exists, the UE 100 may abort the PS signalling connection before enabling the network access mode capability for 3GPP access; or
if the UE 100 is in the S1 mode and is in the EMM-IDLE mode as specified in 3GPP TS 24.301, the UE 100 should enable the network access mode capability for 3GPP access;
if the UE 100 is in the lu mode or the A/Gb mode and an RR connection exists, the UE 100 should delay enabling the network access mode capability for 3GPP access until the RR connection is released; and
if the UE 100 is in the S1 mode and is in the EMM-CONNECTED mode as specified in 3GPP TS 24.301, the UE 100 should delay enabling the network access mode capability for 3GPP access until the NAS signalling connection in the S1 mode is released.

When the UE 100 enables the network access mode capability (the N1 mode capability or the EUTRA mode capability) for 3GPP access, the UE 100 shall remove the PLMN or SNPN from the memorized identity of the PLMNs or SNPNs where the network access mode capability for 3GPP access was disabled.

The UE behavior in Disabling and re-enabling of UE's E-UTRA capability is defined as follows.

As an implementation option, the UE 100 may start a timer for enabling E-UTRA when the UE 100 disables E-UTRA capability. The UE 100 should memorize the identity of the PLMNs where E-UTRA capability was disabled. On expiry of this timer:
if the UE 100 is in the lu mode or the A/Gb mode and is in the idle mode as specified in 3GPP TS 24.008, the UE 100 should enable the E-UTRA capability;
if the UE 100 is in the lu mode or the A/Gb mode and an RR connection exists, the UE 100 shall delay enabling E-UTRA capability until the RR connection is released;
if the UE 100 is in the lu mode and a PS signalling connection exists but no RR connection exists, the UE 100 may abort the PS signalling connection before enabling E-UTRA capability; or
if the UE 100 is in the network access mode (the N1 mode or the EUTRA mode) and is in the 5GMM-IDLE mode as specified in 3GPP TS 24.501, the UE 100 should enable the E-UTRA capability; and
if the UE 100 is in the network access mode and is in the 5GMM-CONNECTED mode as specified in 3GPP TS 24.501, the UE 100 shall delay enabling the E-UTRA capability until the network access NAS signalling connection is released.

When the UE 100 enables E-UTRA capability, the UE 100 shall delete the PLMN from the memorized identity of the PLMNs where E-UTRA capability was disabled.

An example solution 1 for 5GMM is illustrated as follows.

When network-initiated de-registration procedure is failed due to abnormal cases, then the UE 100 performs the PLMN selection procedure, the SNPN mode selection procedure or the SNPN selection for onboarding services, then the UE 100
may disable the network access mode (the N1 mode or the EUTRA mode) (for selected/current/registered PLMN and/or SNPN)) and/or (the PLMN and/or the SNPN is memorized by the UE 100 due to network-initiated de-registration procedure; and/or
may disable the network access mode (for selected/current/registered PLMN and/or SNPN)) and/or (the PLMN and/or the SNPN is memorized by the UE 100 due to T3502 timer running/started; and/or
may start a timer for enabling the network access mode (for selected/current/registered PLMN and/or SNPN)) and optionally the value of the timer for re-enabling the network access mode capability is recommended to take T3502 timer, if provided by the network, into account (e.g. be the same as the value of T3502).

The abnormal cases includes DEREGISTRATION REQUEST, other 5GMM cause values than those treated in subclause 5.5.2.3.2, cases of 5GMM cause value #11, #15, #22, #72, #74, #75, #76, #77, #78, #79 and #93 . . . etc. that are considered as abnormal cases according to subclause 5.5.2.3.2or no 5GMM cause IE is included, and/or the De-registration type IE indicates “re-registration not required”.

If the value of T3502 timer is indicated as zero or deactivated by the network, an implementation specific non-zero value can be used for the timer for re-enabling the network access mode capability (the N1 mode capability or the EUTRA mode capability) and/or the UE 100 may put the PLMN and/or SNPN into one or more of the following lists:
list of “temporarily forbidden SNPNs” and/or “Forbidden PLMN list”;
list of “permanently forbidden SNPNs”;
list of “temporarily forbidden SNPNs” for onboarding services or localized services, and optionally starts MS implementation specific timer (not shorter than 60 minutes), recommended to take the T3502 or remaining validity of time of the SNPN or GIN broadcasted by the SNPN into consideration (e.g., to be the same as the value of T3502 or remaining validity of time of the SNPN or GIN broadcasted by the SNPN or minimum of (T3502, or remaining validity of time of the SNPN or GIN broadcasted by the SNPN));
list of “permanently forbidden SNPNs” for onboarding services or localized services;
a new list of “temporarily forbidden SNPNs” or “Forbidden PLMNs”;
a new list of “permanently forbidden SNPNs”.

An example solution 1 for EMM is illustrated as follows.

When the network-initiated detach procedure is failed due to abnormal cases, then the UE 100 performs the PLMN selection procedure, then the UE 100
may disable the S1 mode (for selected/current/registered PLMN) and/or (the PLMN is memorized by UE 100 (due to network-initiated detach procedure)); and/or
may disable the network access mode (the N1 mode capability or the EUTRA mode capability) (for selected/current/registered PLMN) and/or (the PLMN is memorized by the UE 100 due to T3402 timer running/started; and/or
may start a timer for enabling the S1 mode and optionally the value of the timer for re-enabling the S1 mode capability is recommended to take T3402 timer, if provided by the network, into account (e.g. be the same as the value of T3402).

If the UE 100 is in the S1 mode, on expiry of the timer, the UE 100 should remove the PLMN from the memorized identity of the PLMNs where the E-UTRA capability was disabled.

For example, if the E-UTRA capability is disabled due to the attach attempt counter of the UE 100 or tracking area updating attempt counter reaches the maximum value, such as 5, or the T3402 timer was running/started when the E-UTRA capability is disabled, the value of the timer for re-enabling E-UTRA capability is recommended to be the same as the value of T3402 timer which follows the handling specified in subclause 5.3.6. If the value of T3402 timer is indicated as zero by the network, an implementation specific non-zero value can be used for the timer for re-enabling E-UTRA capability.

The abnormal cases includes: DETACH REQUEST, other EMM cause values than those treated in clause 5.5.2.3.2 or/and no EMM cause IE is included, and/or the Detach type IE indicates “re-attach not required”.

The UE 100 shall not re-enable the E-UTRA capability when performing a PLMN selection when the UE 100 disables the E-UTRA capability for attach abnormal cases, TAU abnormal cases or Network initiated detach abnormal cases.

If the value of T3402 timer is indicated as zero or deactivated by the network, an implementation specific non-zero value can be used for the timer for re-enabling the S1 mode capability.

The UE 100 may put the PLMN into one or more of the following lists:
“Forbidden PLMN list”;
a new list of “Forbidden PLMNs”.

An example solution 2 for 5GMM is illustrated as follows.

When the network-initiated de-registration procedure is failed due to abnormal cases by a first PLMN and/or SNPN and the UE 100 performs the PLMN selection, the SNPN selection or the SNPN selection mode for onboarding services; and/or
the UE 100 starts a first T3502 timer; and/or
the UE 100 performs PLMN selection, SNPN selection or SNPN selection procedure for onboarding services; and/or
the UE 100 selects a second PLMN and/or SNPN; and/or
the UE 100 initiates registration procedure to the second PLMN and/or SNPN;
then the UE 100 keeps the first T3502 timer running; and
optionally, the UE 100 associates it with the first PLMN and/or SNPN; and
optionally, the UE 100 does not consider the first PLMN and/or SNPN while the first T3502 timer is running in PLMN selection, SNPN selection or SNPN selection procedure for onboarding services procedure.

An example solution 2 for EMM is illustrated as follows.

When the network-initiated detach procedure is failed due to the abnormal cases by a first PLMN and the UE 100 performs an PLMN selection; and/or
the UE 100 starts a first T3402 timer; and/or
the UE 100 performs PLMN selection; and/or
the UE 100 selects a second PLMN; and/or
the UE 100 initiates the registration procedure to the second PLMN;
then the UE 100 keeps the first T3402 timer running; and
optionally, the UE 100 associates it with the first PLMN; and
optionally, the UE 100 does not consider the first PLMN while the first T3402 timer is running in PLMN selection.

Moreover, in abnormal case of the network-initiated de-registration procedure, the UE 100 starts T3502 (Similarly T3402) timer and disable the network access mode capability (the N1 mode capability or the EUTRA mode capability) for selection PLMN or SNPN in both 3GPP and non-3GPP (similarly S1 mode capability). Currently, the UE behavior is not defined when there is request from upper layer to establish an emergency PDU session or to trigger an emergency registration in a PLMN or SNPN when network access mode (S1 mode) capability for that PLMN or SNPN was disabled in both 3GPP and/or non-3GPP due to network-initiated de-registration procedure (detach procedure). To solve this problem, a method to handle emergency call in deregistered state in mobile communication is provided.

Please refer to FIG. 3, which shows a flowchart of a method to handle emergency call in deregistered state in mobile communication according to one embodiment of the present disclosure. The method includes steps S210 to S220. In the step S210, an operation of the UE 100 is monitored.

Next, in the step S220, the UE 100 is controlled to enable the network access mode capability (the N1 mode capability or the EUTRA mode capability) for that SNPN memorized by the UE, if the UE 100 attempts to establish an emergency PDU session in a SNPN where the network access mode capability was disabled due to a registration attempt counter of the UE 100 have reached the maximum value, such as 5.

The UE behavior in Disabling and re-enabling of UE's network access mode capability (the N1 mode capability or the EUTRA mode capability) for 3GPP access is defined as follows.

In one embodiment, the UE 100 shall re-enable the network access mode capability (the N1 mode capability or the EUTRA mode capability) for 3GPP access when the UE 100 performs PLMN selection, SNPN selection or SNPN selection for onboarding services over 3GPP access, unless
disabling of the network access mode capability for 3GPP access was due to a UE-initiated de-registration procedure for 5GS services over 3GPP access not due to switch-off; or
the UE 100 has already re-enabled the network access mode capability for 3GPP access when performing items c) or d) above; or
the UE 100 disables the network access mode capability for 3GPP access for cases described in subclauses 5.5.1.2.7, 5.5.1.3.7 and 5.5.2.3.4.

An example solution for 5GMM 3GPP access is illustrated as follows.

When there is request from upper layer to establish pending IMS emergency PDU session on the PLMN or SNPN and the network access mode capability (the N1 mode capability or the EUTRA mode capability) is disabled for selected PLMN or SNPN due to the network-initiated de-registration procedure, then the UE 100 may enable the network access mode capability for that PLMN or SNPN to process emergency call.

When there is request from upper layer to establish pending IMS emergency PDU session on an SNPN and the network access mode capability (the N1 mode capability or the EUTRA mode capability) is disabled for selected SNPN due to the registration attempt counter of the UE 100 have reached the maximum value, such as 5, or due to network-initiated de-registration procedure, then the UE 100 may enable the network access mode capability for that SNPN to process emergency call.

When there is a request to initiate an emergency registration or the access is for emergency services on a selected/registered/current PLMN or SNPN and network access mode capability (the N1 mode capability or the EUTRA mode capability) is disabled for selected/registered/current PLMN or SNPN due to the registration attempt counter of the UE 100 have reached the maximum value, such as 5, and/or due to network-initiated de-registration procedure, then the UE 100 may enable the network access mode capability for that PLMN or SNPN to process emergency call.

An example solution for 5GMM non-3GPP access is illustrated as follows.

When there is request from upper to establish pending IMS emergency PDU session and/or to initiate an emergency registration and/or the access is for emergency services on a selected/registered/current PLMN or SNPN and the network access mode capability (the N1 mode capability or the EUTRA mode capability) is disabled for selected PLMN or SNPN due to network-initiated de-registration procedure or the registration attempt counter of the UE 100 have reached the maximum value, such as 5, then the UE 100 may enable the network access mode capability for that PLMN and/or SNPN.

An example solution for EMM 3GPP access is illustrated as follows.

When there is request from upper layer to establish pending IMS emergency bearer services on an PLMN and the S1 mode capability is disabled for selected/registered/current PLMN due to network-initiated de-registration procedure, then the UE 100 may enable the S1 mode capability for that PLMN to process emergency call.

When there is to initiate an emergency attach and/or the access is for emergency services on an PLMN and the S1 mode capability is disabled for selected PLMN due to network-initiated de-registration procedure or due to the attach attempt counter of the UE 100 or tracking area updating attempt counter have reached the maximum value, such as 5, then the UE 100 may enable the S1 mode capability for that PLMN to process emergency call.

Please refer to FIG. 4, which illustrates the user equipment (UE) 100 in accordance with an implementation of the present disclosure. The user equipment 100 may perform various functions to implement schemes, techniques, processes and methods described herein pertaining to user equipment (UE) behavior in mobile communications, including the various schemes described above with respect to various proposed designs, concepts, schemes, systems and methods described above, including the network environment, as well as processes described below.

The user equipment (UE) 100 may be a part of an electronic apparatus, which may be a network apparatus, such as a portable or mobile apparatus, a wearable apparatus, a vehicular device or a vehicle, a wireless communication apparatus or a computing apparatus. For instance, the user equipment (UE) 100 may be implemented in a smartphone, a smart watch, a personal digital assistant, an electronic control unit (ECU) in a vehicle, a digital camera, or a computing equipment such as a tablet computer, a laptop computer or a notebook computer. The user equipment may also be a part of a machine type apparatus, which may be an IoT apparatus such as an immobile or a stationary apparatus, a home apparatus, a roadside unit (RSU), a wire communication apparatus or a computing apparatus. For instance, the user equipment (UE) may be implemented in a smart thermostat, a smart fridge, a smart door lock, a wireless speaker or a home control center. When implemented in or as a network apparatus, the user equipment (UE) 100 may be implemented in an eNodeB in an LTE, LTE-Advanced or LTE-Advanced Pro network or in a gNB or TRP in a 5G network, an NR network or an IoT network.

In some implementations, the user equipment (UE) 100 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, the user equipment (UE) 100 may be implemented in or as a network apparatus. The user equipment (UE) 100 may include at least some of those components shown in the FIG. 4, such as a processor 110, a transceiver 120 and a memory 130, for example. The user equipment (UE) 100 may further include one or more other components not pertinent to the proposed scheme of the present disclosure (e.g., internal power supply, display device and/or user interface device).

In one aspect, the processor 110 may be implemented in the form of one or more single-core processors, one or more multi-core processors, or one or more CISC or RISC processors. That is, even though a singular term “a processor” is used herein to refer to the processor 110, the processor 110 may include multiple processors in some implementations and a single processor in other implementations in accordance with the present disclosure. In another aspect, the processor 110 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, the processor is a special-purpose machine specifically designed, arranged and configured to perform specific tasks including those pertaining to the user equipment (UE) 100 behavior for failed registration and service requests for emergency services fallback in mobile communications in accordance with various implementations of the present disclosure.

The transceiver 120 is coupled to the processor 110. The transceiver 120 may be capable of wirelessly transmitting and receiving data. In some implementations, the transceiver 120 may be capable of wirelessly communicating with different types of wireless networks of different radio access technologies (RATs). In some implementations, the transceiver 120 may be equipped with a plurality of antenna ports (not shown) such as, for example, four antenna ports. That is, the transceiver 120 may be equipped with multiple transmit antennas and multiple receive antennas for multiple-input multiple-output (MIMO) wireless communications.

The memory 130 is coupled to the processor 110 and stores data therein. The memory 130 may include a type of random-access memory (RAM) such as dynamic RAM (DRAM), static RAM (SRAM), thyristor RAM (T-RAM) and/or zero-capacitor RAM (Z-RAM). Alternatively, or additionally, the memory 113 may include a type of read-only memory (ROM) such as mask ROM, programmable ROM (PROM), erasable programmable ROM (EPROM) and/or electrically erasable programmable ROM (EEPROM). Alternatively, or additionally, the memory 130 may include a type of non-volatile random-access memory (NVRAM) such as flash memory, solid-state memory, ferroelectric RAM (FeRAM), magnetoresistive RAM (MRAM) and/or phase-change memory.

The processor 110 of the user equipment (UE) 100, is configured to perform operations described as above.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A method for operating a user equipment (UE), comprising:
monitoring an operation of the UE; and
controlling the UE to start a timer for enabling a network access mode capability for the 3GPP access when the UE disables the network access mode capability for 3GPP access due to a network initiated procedure;
wherein the UE memorizes an identity of PLMNs or SNPNs where the network access mode capability for the 3GPP access was disabled.

2. The method according to claim 1, wherein the network access mode capability is a N1 mode capability or an EUTRA mode capability.

3. The method according to claim 1, wherein the network initiated procedure is a network initiated deregistration procedure or a network initiated detach procedure.

4. The method according to claim 1, wherein on expiry of this timer,
if the UE is in a lu mode or an A/Gb mode and is in an idle mode, the UE enables the network access mode capability for 3GPP access.

5. The method according to claim 1, wherein on expiry of this timer,
if the UE is in the lu mode and a PS signalling connection exists, but no RR connection exists, the UE aborts the PS signalling connection before enabling the network access mode capability for 3GPP access.

6. The method according to claim 1, wherein on expiry of this timer,
if the UE is in a S1 mode and is in an EMM-IDLE mode, the UE enables the network access mode capability for 3GPP access.

7. The method according to claim 1, wherein on expiry of this timer,
if the UE is in the lu mode or the A/Gb mode and the RR connection exists, the UE delays enabling the network access mode capability for 3GPP access until the RR connection is released.

8. The method according to claim 1, wherein on expiry of this timer,
if the UE is in the S1 mode and is in an EMM-CONNECTED mode, the UE delays enabling the network access mode capability for 3GPP access until the NAS signalling connection in the S1 mode is released.

9. A method for operating a user equipment (UE), comprising:
monitoring an operation of the UE; and
controlling the UE to enable a network access mode capability for that SNPN memorized by the UE, if the UE attempts to establish an emergency PDU session in a SNPN where the network access mode capability was disabled due to a registration attempt counter of the UE have reached a maximum value.

10. The method according to claim 9, wherein the network access mode capability is a N1 mode capability.

11. The method according to claim 9, wherein the maximum value is 5.

12. A user equipment (UE), comprising:
a transceiver, configured to wirelessly communicate with a network; and
a processor, coupled to the transceiver and configured to perform operations comprising:
monitoring an operation of the UE; and
controlling the UE to start a timer for enabling a network access mode capability for the 3GPP access when the UE disables the network access mode capability for 3GPP access due to a network initiated procedure;
wherein the UE memorizes an identity of PLMNs or SNPNs where the network access mode capability for the 3GPP access was disabled.

13. The user equipment (UE) according to claim 12, wherein the network access mode capability is a N1 mode capability or an EUTRA mode capability.

14. The user equipment (UE) according to claim 12, wherein the network initiated procedure is a network initiated deregistration procedure or a network initiated detach procedure.

15. The user equipment (UE) according to claim 12, wherein on expiry of this timer,
if the UE is in a lu mode or an A/Gb mode and is in an idle mode, the UE enables the network access mode capability for 3GPP access.

16. The user equipment (UE) according to claim 12, wherein on expiry of this timer,
if the UE is in the lu mode and a PS signalling connection exists, but no RR connection exists, the UE aborts the PS signalling connection before enabling the network access mode capability for 3GPP access.

17. The user equipment (UE) according to claim 12, wherein on expiry of this timer,
if the UE is in a S1 mode and is in an EMM-IDLE mode, the UE enables the network access mode capability for 3GPP access.

18. The user equipment (UE) according to claim 12, wherein on expiry of this timer,
if the UE is in the lu mode or the A/Gb mode and the RR connection exists, the UE delays enabling the network access mode capability for 3GPP access until the RR connection is released.

19. The user equipment (UE) according to claim 12, wherein on expiry of this timer,
if the UE is in the S1 mode and is in an EMM-CONNECTED mode, the UE delays enabling the network access mode capability for 3GPP access until the NAS signalling connection in the S1 mode is released.
